(19) United States
(12) Patent Application Publication
(10) Pub. No.: US 2002/0082719 A1
(43) Pub. Date: Jun. 27, 2002

(54) Method and device to automatically restart a blocked computer

(76) Inventor: Paolo Forlani, Milano (IT)

Correspondence Address: PAOLO FORLANI, VIALE CIRENE 7, MILANO, I 20135, IT

(21) Appl. No.: 09/747,438

(22) Filed: Dec. 26, 2000

(51) Int. Cl. G05B 11/01

(52) U.S. Cl. 700/12

(57) ABSTRACT

Method and device to restart automatically a blocked computer. When the block is detected, the electrical power to the computer is switched off and on again and the device repeats automatically the sequence of key presses that would be executed by a human operator to restart the operating system. This sequence and its timing are stored in the device during a previous self training phase.

### BACKGROUND OF THE INVENTION

Among the many applications of computers and personal computers (PC), there are those that need to work without interruptions and without attendance. Applications of this kind are local area network servers, Internet servers, industrial automation systems, electronic mail transmission systems and many others.

Unfortunately, with a certain frequence, it happens that the PC gets blocked and does not execute its assigned work anymore; a human intervention is necessary, and in many cases the operator just switches off and on again the PC and then types on the keyboard the commands needed to restart it.

Blocks due to a real hardware failure, that needs a repair, are much less frequent.

The block can be related to the operating system, to one of the programs running or to the general operation of the PC and can be due to many reasons; in the majority of cases the operator does not understand the cause of the block and limits his action to the above mentioned restart sequence without other corrective actions.

The stop of a computerized system, even if it is rare, has often heavy consequences that span from the interruption of a service to the loss of material and other damages in the case of an industrial plant control.

The manual intervention of the operator, who is often distant from the computer and has to come back to restart the system, causes loss of time and high costs, also considering that the block is often detected with some delay.

To overcome this problem, antiblocking devices often named “watchdogs” have been devised; these devices can detect the block of the PC and can restart it automatically.

The operation of these devices is based on a timer. At predefined time intervals, a supervisory program running in the computer accesses the hardware of the watchdog and restarts the timer from zero. If this action is not done and the time elapses, the device generates the “reset” signal of the PC and restarts its operation.

These devices, already on the market, have several limitations that compromise their usefulness and often make them completely unsuitable:

They have the form of an additional board to be mounted inside the PC; their installation requires the intervention of a specialized engineer and the device must match the internal bus (ISA, PCI. . .) of the PC where it is installed, while the fast evolution in the word of computers produces a frequent change of the type of buses;

They only generate the internal “reset” signal of the PC (same as pushing the reset button on the front panel), but this action often cannot restart all internal and external peripherals of the PC;

They are not capable, at the moment of the restart, to perform some essential operations, different from one system to another, such as:

The action of typing the commands needed to restart the operating system after the block, necessary because many systems, after a brute force stop, resume their operation in diagnostic mode;

The action of typing the password of the network the computer is connected with: in the majority of operating systems, this action cannot be performed automatically by a program and must be done with the keyboard, even if the human action is limited to pressing the “enter” key to confirm an empty password.

In conclusion we can say that, for many systems that work unattended, there is the possiblity of a block that produces the stop of the service and material losses; the service can be resumed only with the personal intervention of an engineer.

### SUMMARY OF THE INVENTION

The invention described here relates to the method to solve the above indicated problems.

The invention uses a relay that, when the block detect time elapses, interrupts and then resumes the electical power supply to the computer, and a connection with the keyboard port through which, after the restart of the operation, the system simulates the typing of commands by a human operator, who does not need to be present anymore.

The sequence of commands to be typed for restarting is stored in an appropriate non-volatile memory during a previous self-training phase, in which the sequence of keys pressed by a human operator and their timing is read from the keyboard port. The timing is the duration of the time intervals that the operator leaves between single key presses.

### BRIEF DESCRIPTION OF THE DRAWINGS

FIG.1 shows the construction of the watchdog device and its connections with the computer.

FIG.2 shows a block diagram of the hardware of the device.

FIG.3 shows the software flow chart of the self-training phase.

FIG.4 shows the software flow chart of the computer restart phase.

### DETAILED DESCRIPTION OF THE PREFERRED EMBODIMENT

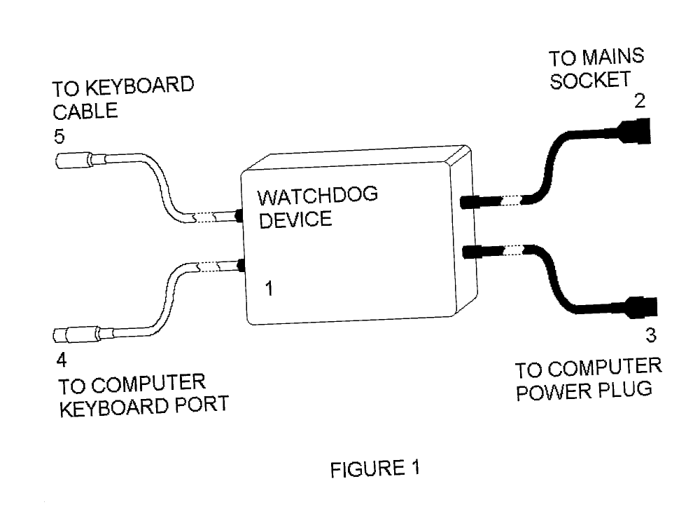

As shown in FIG.1, the device is housed in a box 1 separated from the PC to be protected. The connections with the PC are two:

With a pair of male and female connectors 2 and 3, the device is inserted between the power supply (electrical 115/220 V network or other) and the power supply plug of the computer; i.e. “in series” with the power supply;

With a pair of male and female connectors 4 and 5, the device is inserted between the keyboard cable and the keyboard socket at the back of the PC, i.e. “in series” with the keyboard.

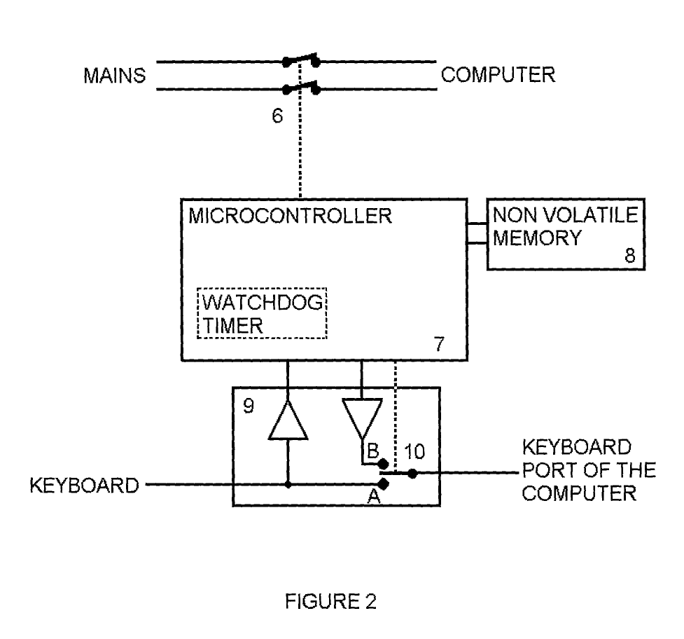

As shown in the block diagram of FIG.2, the device includes:

The relay 6 used to interrupt the 115/1220 V power supply:

A microcontroller 7 with a non-volatile memory 8 where the restart sequence is stored;

A watchdog timer made using an internal timer of the microcontroller 7;

A bidirectional interface circuit 9 with an electronic switch 10 that allows the following operational modes:

With the electronic switch in position A, the device can learn the key sequence needed to restart, because it can see the codes of all the keys pressed by the human operator during a simulated restart operation, and it can also read their exact timing;

With the electronic switch in position A, the programs running in the PC can reset the watchdog timer by sending to the keyboard some codes that do not disturb the operation of the keyboard, but that can be seen by the microcontroller and can produce the restart of the timer:

With the electronic switch in position B, the device can simulate any kind of human operation on the keyboard, because simulated keypresses are seen by the programs as if they were typed by an operator;

With the electronic switch in position A, with appropriate codes, a bidirectional communication can be initiated between the programs running in the PC and the firmware inside the microcontroller 7; after the initial phase in position A, the switch is set by the microcontroller to position B and reasonably short sequences of data can be sent between the two programs without noticeably disturbing the operation of the keyboard. This function can be used for instance to set parameters in the device (such as the duration of the watchdog timeout) by means of a command by a program in the PC.

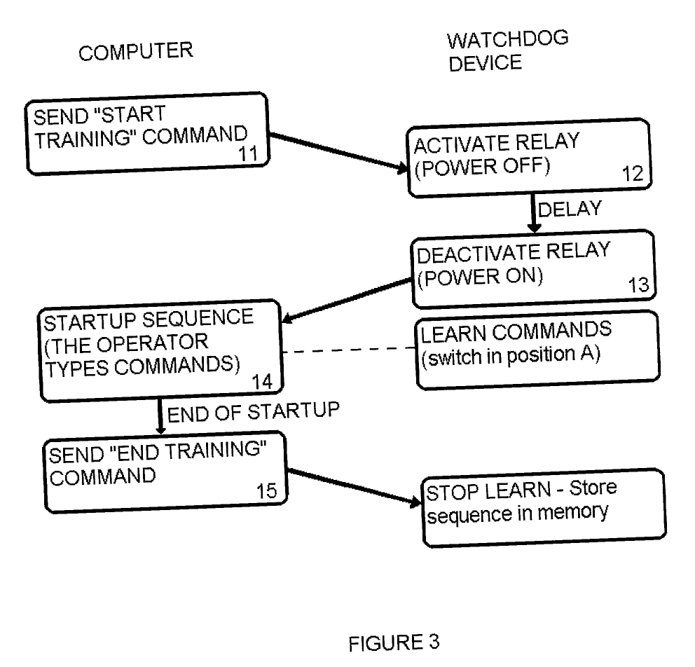

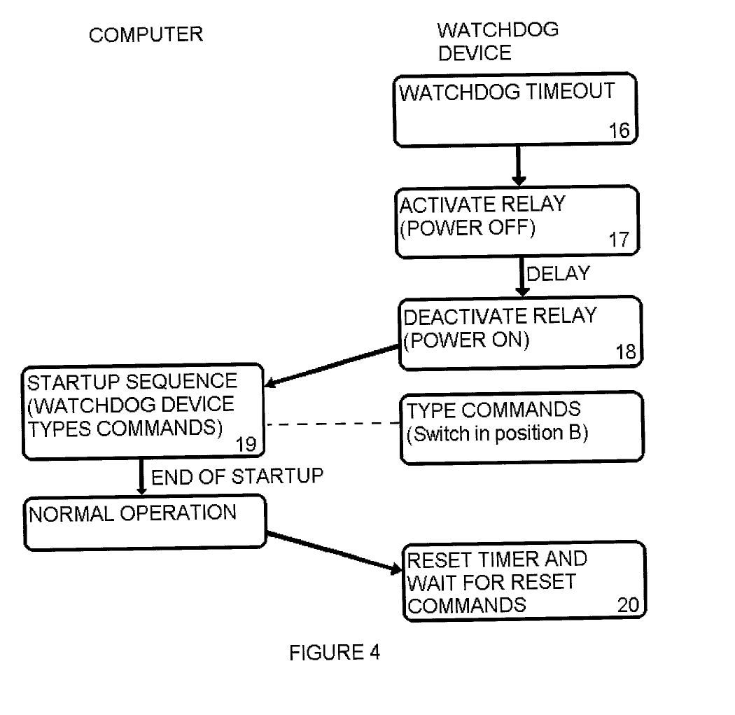

FIG.3 and FIG.4 show a simple flow diagram of the program in the microcontroller 7, in the two most important phases of the operation.

In FIG.3, it can be seen that:

The training operation is initiated by a special command 11 from the PC to the device;

The device switches OFF the power by operating the relay (12);

The device switches ON the power by releasing the relay (13);

The operator types the restart commands while the device stores them (14);

When the operation resumes, the supervisory program in the computer sends a code to the device, to indicate the end of the training phase (15).

In FIG.4, it can be seen that:

The reset operation starts when the watchdog time elapses (16);

The device switches OFF the power by operating the relay (17);

The device switches ON the power by releasing the relay (18);

The device repeats the commands stored in its memory (19) with the stored timing;

The device resets the watchdog timer to its nominal value and starts waiting for timer reset commands from the PC (20).

Other advantages of this kind of construction are:

The device is independent from the bus and from the internal technology of the PC;

Specialized personnel to open the PC and install the device is not required;

It allows the interruption of the electrical power supply to the PC, thus allowing the complete stop and restart of the computer and of other peripherals operated from the electrical supply, that can be powered by the voltage after the relay.

Although the invention has been described in detail for the purpose of illustration only, it is understood that such detail is solely for that purpose and that many variations, changes, additions and substitutions can be made therein by those of ordinary skill in the art without departing from the spirit and scope of the invention, as defined by the following claims, including all equivalents thereof.

1. Method and device to restart automatically a blocked computer, with a second microcontroller separated from the main processor.

2. The device of claim 1 wherein the device is connected “in series” with the electrical power supply line.

3. The device of claim 1 wherein the device can interrupt the electrical power to the computer by means of a relay.

4. The device of claim 1 wherein the device is connected “in series” with the keyboard cable.

5. The device of claim 1 wherein the device can simulate a sequence of key presses on the keyboard.

6. The device of claim 1 wherein the device can learn a sequence of keys pressed on the keyboard by a human operator.

7. The device of claim 1 wherein the device has an internal watchdog timer that is reset by means of special codes sent by a supervisory program running in the computer through the keyboard cable.

8. The device of claim 1 wherein the device can communicate bidirectionally with a supervisory program running in the computer by means of codes sent through the keyboard cable

9. Device against the blocking of computers, substantially as above described, for the above indicated purposes.
